(19) United States
(12) Patent Application Publication
(10) Pub. No.: US 2013/0272762 A1
(43) Pub. Date: Oct. 17, 2013

(54) IMAGE HEATING APPARATUS

(71) Applicant: CANON KABUSHIKI KAISHA, Tokyo (JP)

(72) Inventors: Eiji Uekawa, Susono-shi (JP); Tohru Saito, Mishima-shi (JP); Atsutoshi Ando, Yokohama-shi (JP); Masashi Tanaka, Kawasaki-shi (JP)

(73) Assignee: CANON KABUSHIKI KAISHA, Tokyo (JP)

(21) Appl. No.: 13/855,314

(22) Filed: Apr. 2, 2013

(30) Foreign Application Priority Data
Apr. 11, 2012 (JP) 2012-089998

(51) Int. Cl. G03G 15/20

(52) U.S. Cl. CPC G03G 15/2064
USPC 399/329

(57) ABSTRACT

The image heating apparatus includes an endless belt, a roller which contacts an outer face of the belt, a nip portion forming unit which contacts an inner face of the belt, and forms a nip portion with the roller, for nipping and conveying a recording material, the nip portion forming unit including a component which is longer than the belt in a generatrix direction of the belt; and a regulation portion provided to oppose an end face of the belt, for regulating a shift movement of the belt to the generatrix direction of the belt, wherein the regulation portion is integrally-molded with the component. Thereby, a damage of the end of the endless belt can be reduced.

### BACKGROUND OF THE INVENTION

1. Field of the Invention

The present invention relates to an image heating apparatus which can be used as a fixing apparatus (fixing device) that is mounted on an image forming apparatus such as an electrophotographic copier and an electrophotographic printer.

2. Description of the Related Art

A film (belt) heating type of fixing apparatus is known as a fixing apparatus (fixing device) which is mounted on an electrophotographic copier and an electrophotographic printer. This film heating type of fixing apparatus has a heater having a current-energized heat generating member on a substrate made from ceramic, a cylindrical fixing film (endless belt) which rotates while coming into contact with the heater, and a pressure roller which forms a nip portion with the heater through the fixing film. A recording material which carries an unfixed toner image thereon is heated while being sandwiched in the nip portion and conveyed therethrough, and thereby, a toner image on the recording material is heated and fixed onto the recording material.

This type of fixing apparatus has such a merit that a period of time for raising the temperature of the heater to a fixable temperature after the energization to the heater has started is short. Accordingly, a printer having this fixing apparatus mounted thereon can shorten a period of time (FPOT: First Print Out Time) for outputting the first sheet of an image after a command to print has been input thereinto. This type of fixing apparatus has also such a merit that an electric power to be consumed while waiting for the command to print is little.

A resin film or a metal sleeve is used as the fixing film. When the resin film and the metal sleeve are not distinguished from each other in the following description, the resin film and the metal sleeve shall be altogether referred to as a fixing film. There are many cases where the fixing film receives a shift force toward any one direction in a longitudinal direction (generatrix direction) of the fixing film, due to influences of a balance in alignment with the pressure roller, a difference between outer diameters of both ends of the fixing film in the longitudinal direction, and the introduction (sheet-feeding) of the recording material to the nip portion.

Japanese Patent Application Laid-Open No. H04-204980 and Japanese Patent Application Laid-Open No. H05-208750 disclose a method for providing a shift regulation portion (regulation flange) in the outside of both ends in the longitudinal direction of the fixing film so as to regulate a shift of the fixing film to the longitudinal direction, and thereby preventing the damage and wear in the end in the longitudinal direction of the fixing film.

An assembled structure of the regulation flange in the fixing apparatus of a comparative example will be described below with reference to FIGS. 13 to 15. FIG. 13 illustrates the assembled structure of the regulation flange 101 in one end side of the fixing film 104 in a longitudinal direction, but the assembled structure of the regulation flange in the other end side of the fixing film 104 in the longitudinal direction also has the same structure as that in the one end side.

The regulation flange 101 has a regulation portion 101a having an end regulation face 101a1 for regulating the shift of the fixing film 104 to the longitudinal direction, a spring receiving portion 101b for holding one end of a pressure spring 103, a guide portion 101c for guiding the trajectory of the fixing film during rotation, and the like. The bottom parts of the regulation portion 101a and the guide portion 101c of the regulation flange 101 support one end of a heater (not-shown) in a longitudinal direction, and the guide portion 101c supports the one end of the fixing film 104 in the longitudinal direction.

A groove for guiding the regulation flange 101 is provided on a frame member 102 (fixing frame) of the fixing apparatus. In the regulation flange 101, a groove portion 101d (see FIG. 15) provided on the regulation flange 101 fits into the groove of the frame member 102. Thereby, the position of the regulation portion 101a is determined. Alternatively, the position of the regulation portion 101a is determined by fitting of the groove portion 101d provided on the regulation flange 101 into a part of a not-shown frame member (main body frame) of the main body of the image forming apparatus. A pressure force due to the pressure spring 103 is applied to the spring receiving portion 101b, and the pressure force due to the pressure spring 103 forms a fixing nip portion N.

Here, suppose the case where the whole regulation flange 101 tilts downward in the outer side in the longitudinal direction of the fixing film 104, due to a factor such as an assembly tolerance (see FIG. 14). In the state in which the whole regulation flange 101 tilts as is illustrated in FIG. 14, a shift force may be generated in a direction shown by an arrow in the fixing film 104 while the fixing film 104 is rotated, and the end face of one end in the longitudinal direction of the fixing film 104 may abut on the regulation face 101a1. In this case, in a portion which is close to the fixing nip portion N surrounded by a circular chained line S1, the end face of the one end in the longitudinal direction of the fixing film 104 locally comes into contact with the regulation face 101a1.

If a strong shift force has acted on the fixing film 104 in such a state that the regulation flange 101 tilts as in the above description, the end in the longitudinal direction of the fixing film (hereinafter referred to as film end) receives a stress and is facilitated to be bent.

In addition, such an action becomes strong that the guide portion 101c of the regulation flange 101 expands an inner peripheral face (inner face) of the fixing film 104 to the outside, in a portion surrounded by a circular chained line S2, and such a risk also increases that this stress damages the end in the longitudinal direction of the fixing film 104.

In addition, there is also the case where the whole regulation flange 101 tilts toward the upper-stream side of the recording material conveyance direction because of a factor such as the assembly tolerance (see FIG. 15), or where the whole regulation flange 101 tilts toward the down-stream side of the recording material conveyance direction. If a shift force has been generated in the fixing film 104 in a direction shown by an arrow while the fixing film 104 is rotated in a state in which the whole regulation flange 101 tilts toward the upper-stream side of the recording material conveyance direction as is illustrated in FIG. 15, the shift force acts on portions S3 and S4 shown by a circular dashed line in a similar way. Because of this, the action of the shift force results in increasing a risk of damaging the end in the longitudinal direction of the fixing film 104.

In order to reduce such a risk, various measures are implemented which include, for instance, reducing a fitting clearance of the frame member 102 of the fixing apparatus or the regulation flange 101 with respect to the frame member of the main body of the image forming apparatus, and forming the shape of the end regulation face 101a1 into a curved surface. However, it is difficult to eliminate the tilt of the whole regulation flange 101, and the damage of the end and the wear of the end in the longitudinal direction of the fixing film 104 have not been solved yet.

Such a problem that the endless belt is damaged is not limited to an apparatus using a ceramic heater, but is a common problem among apparatuses using the endless belt.

### SUMMARY OF THE INVENTION

With respect to the above described problems, a purpose of the present invention is to provide an image heating apparatus which can suppress a damage of an endless belt.

Another purpose of the present invention is to provide an image heating apparatus that includes an endless belt, a roller which contacts an outer face of the belt, a nip portion forming unit which contacts an inner face of the belt, and forms a nip portion with the roller, for nipping and conveying a recording material, the nip portion forming unit including a component which is longer than the belt in a generatrix direction of the belt, and a regulation portion provided to oppose an end face of the belt, for regulating a shift movement of the belt to the generatrix direction of the belt, wherein the regulation portion is integrally-molded with the component.

Further features of the present invention will become apparent from the following description of embodiments with reference to the attached drawings.

### BRIEF DESCRIPTION OF THE DRAWINGS

FIG. 1 is a schematic view of a schematic structure of one example of an image forming apparatus.

FIG. 2 is a transverse sectional view illustrating a schematic structure at the center in a longitudinal direction of a fixing apparatus according to Embodiment 1.

FIG. 3A is a front view illustrating the schematic structure of the fixing apparatus when viewed from a recording material introduction side. FIG. 3B is an enlarged side view of the fixing apparatus in FIG. 3A when viewed from the direction of the arrow A. FIG. 3C is a perspective view illustrating an end of a heat insulation holder.

FIG. 4A is a front view illustrating a state in which a fixing film is inserted into the heat insulation holder that supports a heater and a metal stay.

FIG. 4B is a side view illustrating the heat insulation holder which supports the heater and the metal stay, and the fixing film, in FIG. 4A, when viewed from the direction of the arrow B.

FIG. 5A is a front view of one side in a longitudinal direction of the fixing film and a pressure roller.

FIG. 5B is an explanatory drawing of a guide portion provided in one side in a longitudinal direction of the heat insulation holder.

FIG. 5C is an enlarged side view of the fixing film and the pressure roller of FIG. 5A when viewed from the direction of the arrow C.

FIG. 6 is a front view illustrating a schematic structure of a fixing apparatus of a comparative example when viewed from the recording material introduction side.

FIG. 7 is an explanatory drawing for describing Comparative Experiment 1 for the fixing apparatus of the comparative example.

FIG. 8 is an explanatory drawing for describing Comparative Experiment 2 for the fixing apparatus of the comparative example.

FIG. 9A is a front view of the fixing apparatus according to Embodiment 2 when viewed from the recording material introduction side.

FIG. 9B is an explanatory drawing of a shift regulation flange incorporated in the heat insulation holder of the fixing apparatus.

FIG. 10A is a front view of the fixing apparatus according to Embodiment 2 when viewed from the recording material introduction side, and is a view illustrating one example of the size of a shift regulation portion of the heat insulation holder.

FIG. 10B is an enlarged side view of the fixing apparatus of FIG. 10A when viewed from the direction of the arrow D, and is a view illustrating one example of a shape of the shift regulation portion of the heat insulation holder.

FIG. 11 is an explanatory drawing illustrating one example of spiral-shaped unevenness formed on the inner face of the fixing film, in the fixing apparatus according to Embodiment 2.

FIG. 12A is a front view of a fixing apparatus according to Embodiment 3 when viewed from the recording material introduction side.

FIG. 12B is an enlarged side view of the fixing apparatus of FIG. 12A when viewed from the direction of the arrow E.

FIG. 13 is a view illustrating an assembled structure of a regulation flange in the fixing apparatus of the comparative example.

FIG. 14 is a view illustrating a state in which the whole regulation flange tilts, in the fixing apparatus of the comparative example.

FIG. 15 is a view illustrating a state in which the whole regulation flange tilts toward the upper-stream side of the recording material conveyance direction, in the fixing apparatus of the comparative example.

### DESCRIPTION OF THE EMBODIMENTS

Preferred embodiments of the present invention will now be described in detail in accordance with the accompanying drawings.

### Embodiment 1

### (1) Example of Image Forming Apparatus

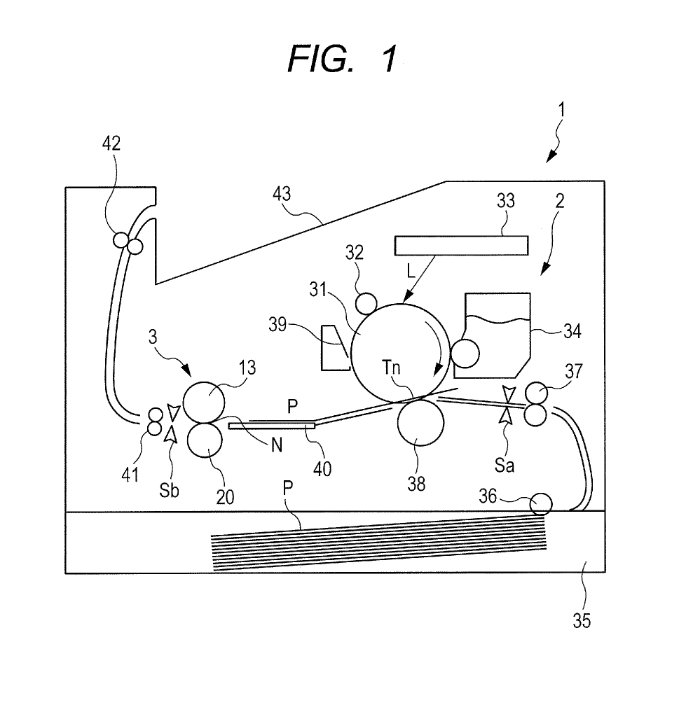

FIG. 1 is a schematic block diagram of one example of an image forming apparatus having an image heating apparatus mounted thereon, as a fixing apparatus according to the present invention. This image forming apparatus is an electrophotographic laser printer.

An image forming apparatus 1 illustrated in the present embodiment has an image-forming portion 2 for forming an unfixed toner image (unfixed image) on a recording material such as a recording paper, a fixing device (fixing portion) 3 for heating the unfixed toner image carried on the recording material and fixing the unfixed toner image onto the recording material, and the like.

In the image forming apparatus 1 of the present embodiment, a cylindrical electrophotographic photosensitive member (hereinafter referred to as photosensitive drum) of an image carrying body is rotated in a direction shown by an arrow according to a command to print, which is input from an external apparatus (not-shown) such as a host computer. A photosensitive drum obtained by forming a photosensitive material such as OPC, amorphous Se and amorphous Si on a cylindrical base of aluminum, nickel or the like is used as a photosensitive drum 31.

When the photosensitive drum 31 is rotated, firstly, the outer peripheral face (surface) of the photosensitive drum 31 becomes uniformly charged to a predetermined potential/polarity by a charge roller 32 of a charging unit. Next, the charged face of the surface of the photosensitive drum 31 is scanned and exposed by a laser beam L which has been ON/OFF controlled according to image information and is emitted from a laser scanner 33 of an exposure unit, and an electrostatic latent image is formed on the charged face of the surface of the photosensitive drum 31. This electrostatic latent image is developed with the use of a toner in a development apparatus 34 of a development unit, and the developed image is visualized. A jumping development method, a two-component development method, a FEED development method and the like are used as a development method, and are used in combination with image exposure and reversal development in many cases.

On the other hand, a sheet of a recording material P is fed one by one from a feeding cassette 35 by a feeding roller 36, is sandwiched between conveyance rollers 37 and is conveyed (sandwiched and conveyed) in the state. The conveyance roller 37 is structured so as to send the recording material P to a transfer nip portion Tn which is formed of the surface of the photosensitive drum 31 and the outer peripheral face (surface) of a transfer roller 38 of a transfer unit at predetermined timing. The conveyance roller 37 stops the conveyance of the recording material P at timing at which a top sensor Sa has detected the tip of the recording material P. The conveyance roller 37 conveys the recording material P toward the transfer nip portion Tn so that an image formation starting position of the toner image on the surface of the photosensitive drum and a writing position on the tip of the recording material P coincide with each other on the transfer nip portion Tn.

The recording material P is sandwiched in the transfer nip portion Tn which is formed between the surface of the photosensitive drum 31 and the surface of the transfer roller 38, and is thereby conveyed. In the conveyance process, the toner image on the surface of the photosensitive drum 31 is transferred onto the recording material P by the transfer roller 38. Thereby, the recording material P carries an unfixed toner image (unfixed image) on the surface which opposes the photosensitive drum 31.

The transfer remainder toner which remains on the surface of the photosensitive drum 1 after having transferred the toner image to the recording material P is removed by a cleaning blade 39 of a cleaning unit, and thereby the photosensitive drum 1 is supplied to next image formation.

The recording material P having the unfixed toner image carried thereon is separated from the surface of the photosensitive drum 31, and is introduced to a fixing device (hereinafter referred to as fixing apparatus) 3 through a conveyance guide 40. In the fixing apparatus 3, the recording material P is sandwiched in the fixing nip portion (nip portion) N which is formed by the fixing film 13 of a cylindrical flexible member (endless belt) and the pressure roller 20 of a pressure rotation member, and is conveyed therethrough. Thereby, the unfixed toner image is heated and fixed onto the recording material P. The recording material P which has exited from the fixing nip portion N is discharged onto a discharge toner 43 by discharge rollers 41 and 42.

An ejected paper sensor Sb is provided between the discharge roller 41 and the fixing apparatus 3. The ejected paper sensor Sb is a sensor for detecting the jamming of paper when the paper is jammed between the top sensor Sa and the ejected paper sensor Sb.

### (2) Fixing Apparatus 3

In the following description, a longitudinal direction concerning a fixing apparatus and members which constitute the fixing apparatus means a direction perpendicular to a recording material conveyance direction, on the surface of the recording material. A transverse direction means a direction parallel to the recording material conveyance direction, on the surface of the recording material. A length means a dimension in the longitudinal direction. A width means a dimension in the transverse direction. A width direction concerning the recording material means a direction perpendicular to the recording material conveyance direction, on the surface of the recording material. The width concerning the recording material means a dimension in the width direction.

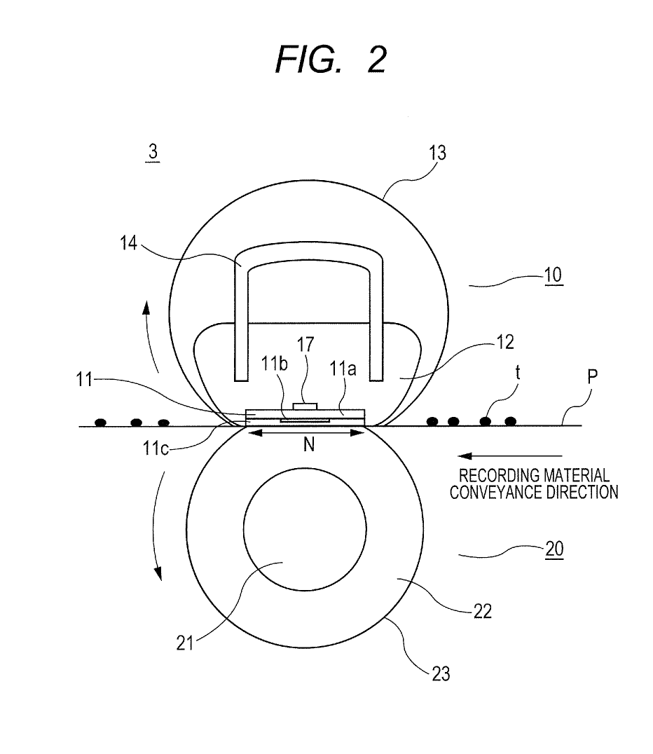

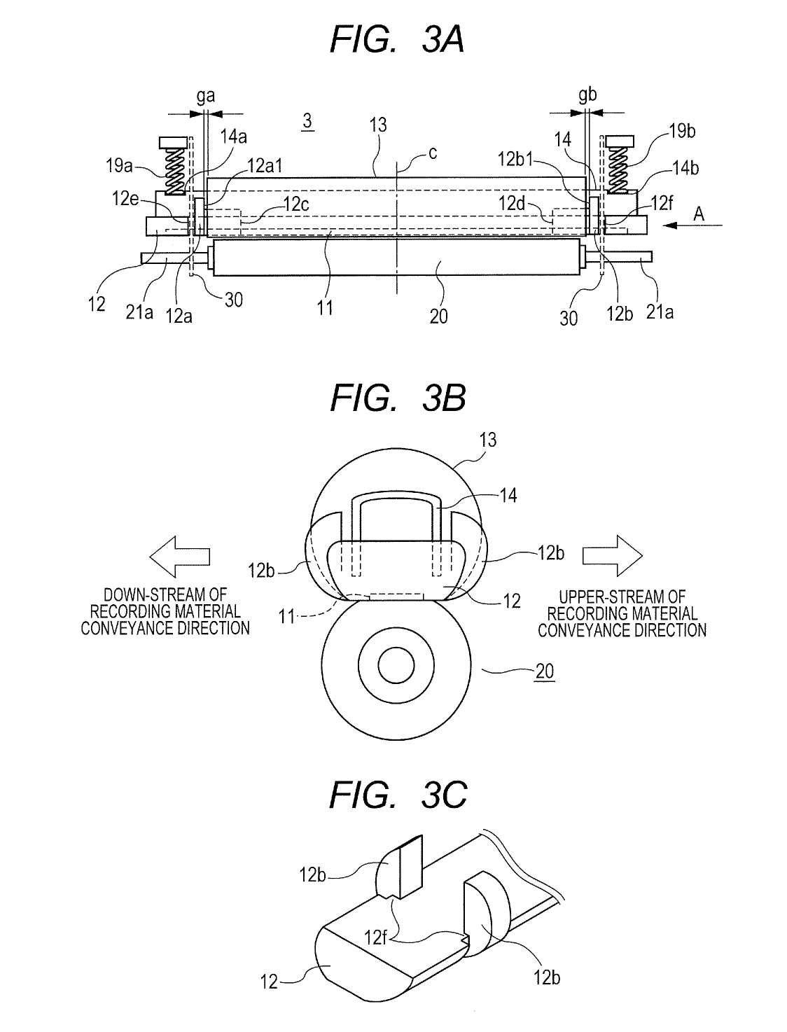

FIG. 2 is a transverse sectional view illustrating a schematic structure, at the center in the longitudinal direction of the fixing apparatus 3. FIG. 3A is a front view illustrating the schematic structure of the fixing apparatus 3 when viewed from a recording material introduction side, and FIG. 3B is an enlarged side view of the fixing apparatus 3 of FIG. 3A when viewed from the direction of the arrow A. FIG. 3C is a perspective view illustrating an end of a heat insulation holder. The fixing apparatus is a film heating type of apparatus.

The fixing apparatus 3 illustrated in the present embodiment has a fixing assembly 10, the pressure roller 20 and the like. The fixing assembly 10 has a fixing film (endless belt) 13, a heater 11 as a heating element, a heat insulation holder 12 of a supporting member, a metal stay 14 of a support member, a pressure spring 19 of a pressure unit, and the like. All of the fixing film 13, the heater 11, the heat insulation holder 12, the metal stay 14, and the pressure roller 20 are members which are long in a longitudinal direction. As is illustrated in FIG. 3A, all of these members are arranged so as to be symmetrical with respect to the center c in the longitudinal direction of the fixing apparatus 3. In addition, the length of these members are set so as to satisfy the relation of pressure roller 20<fixing film 13<heater 11<metal stay 14<heat insulation holder 12. Among these components, the heater 11, the holder 12 and the metal stay 14 constitute a nip portion forming unit which comes into contact with the inner face of the film (belt) 13.

### (2-1) Fixing Assembly 10

The heater 11 has low heat capacity, has a plate shape, comes into contact with the inner peripheral face (inner face) of the fixing film 13, and heats the fixing nip portion N. The heater 11 has an insulative ceramic substrate (hereinafter referred to as substrate) 11a made from alumina, aluminum nitride or the like. An current-energized resistance layer 11b made from Ag/Pd (silver palladium), RuO₂, Ta₂N or the like is formed on the surface in the fixing nip portion N side of the substrate 11a, along the longitudinal direction of the substrate 11a, by screen printing or the like. Furthermore, a protection layer 11c such as a glass layer for protecting the current-energized resistance layer 11b is formed in such a range as not to impair the thermal efficiency, on the surface in the fixing nip portion N side of the substrate 11a.

The heat insulation holder 12 is formed from a heat resistant resin material such as a liquid crystal polymer, a phenol resin, PPS (polyphenylene sulfide) and PEEK (polyether ether ketone). The heat insulation holder 12 supports the heater 11 so that the protection layer 11c faces downward. The metal stay 14 of which the cross section has been formed into approximately a U-shape is arranged in the center of the upper face of the heat insulation holder 12. The outside surfaces in both sides in the transverse direction of the heat insulation holder 12 are formed into such an arcuate surface as to swell to the outside, and the arcuate surface is structured so as to guide the rotation of the fixing film 13. The fixing film 13 is rotatably and loosely fitted over the outer perimeter of the heat insulation holder 12 which supports the heater 11 and the metal stay 14.

The fixing film 13 is a heat resistant film which has a cylindrical shape, has flexibility and a total thickness of 200 μm or less, so as to shorten a period of time until the fixing film 13 is heated to a fixable temperature after the energization to the heater 11 has started. The fixing film 13 employs a heat resistant resin such as polyimide, polyamide imide and PEEK, a pure metal such as SUS, Al, Ni, Cu and Zn or an alloy which has heat resistance and high heat conductivity, as a base layer. In addition, the fixing film 13 needs to have a total thickness of 20 μm or more from the viewpoint of durability. Accordingly, the total thickness of the fixing film 13 can be 20 μm or more and 200 μm or less.

Furthermore, a releasing layer is formed on the outer peripheral face (surface) of the fixing film 13, in order to prevent an offset of a toner and secure separability from the recording material P. The fixing film is covered with a substance obtained by mixing a heat resistant resin having adequate mold releasability like a fluorine resin such as PTFE, PFA, FEP, ETFE and CTFE and a silicone resin, or with a sole substance thereof, which is used as the releasing layer. Here, PTFE is polytetrafluoroethylene, and PFA is a tetrafluoroethylene perfluoroalkyl-vinyl-ether copolymer. FEP is a tetrafluoroethylene hexafluoropropylene copolymer, ETFE is an ethylene tetrafluoroethylene copolymer, CTFE is polychlorotrifluoroethylene, and PVDF is polyvinylidene-fluoride.

As described above, the fixing assembly 10 having the heater 11, the heat insulation holder 12, the metal stay 14, the fixing film 13 and the like is supported by a part of a frame member 30 (fixing frame) of the fixing apparatus 3, which is shown by a dashed line in FIG. 3A. In more detail, the position of the fixing assembly 10 (to be precise, nip portion forming unit) is determined, by fitting guide grooves 12e and 12f provided in the ends in the longitudinal direction of the heat insulation holder 12, into the frame member 30.

### (2-2) Pressure Roller 20

The pressure roller 20 is an elastic roller which has an elastic layer 22 on the outer peripheral face between shaft portions 21a (see FIG. 3A) in both ends in the longitudinal direction of a metallic cored metal (hereinafter referred to as cored metal) 21 made from a metal such as SUS (steel used stainless), SUM (steel used machinability) and Al.

An elastic solid rubber layer which has been formed from heat resistant rubber such as silicone rubber and fluorine rubber can be used as the elastic layer 22. Alternatively, an elastic sponge rubber layer can be used which has been formed by foaming the silicone rubber so as to have a more heat resistant effect. Alternatively, an elastic air bubble rubber layer can be used in which hollow fillers (micro balloon or the like) are dispersed in the silicone rubber layer, and gas portions are formed in a cured substance, and the heat resistant effect is enhanced. A releasing layer 23 such as the tetrafluoroethylene/perfluoroalkyl-vinyl-ether copolymer resin (PFA) and a polytetrafluoroethylene resin (PTFE) is formed on the outer peripheral face of the elastic layer 22.

In the present embodiment, an insulating silicone rubber having the micro balloons dispersed therein is used as the elastic layer 22 of the pressure roller 20, and a PFA tube having a thickness of 50 μm is used as the releasing layer 23. In the present embodiment, the length of the elastic layer 22 is determined to be the length of the pressure roller 20.

The pressure roller 20 is arranged so that the surface of the pressure roller 20 opposes the surface of the fixing film 13 in the lower part of the fixing film 13, and at the arranged position, the shaft portions 21a in both ends in the longitudinal direction of the cored metal 21 are rotatably supported by the frame member of the fixing apparatus 3 through bearings (not-shown).

### (2-3) Pressure Mechanism

As is illustrated in FIG. 3A, both ends in the longitudinal direction of the metal stay 14 which reinforces the heat insulation holder 12 are pressurized toward the heat insulation holder 12 by pressure springs 19a and 19b, and thereby the heater 11 is pressurized to the pressure roller 20 through the fixing film 13. The elastic layer 22 is elastically deformed in a region in which the heater 11 is pressurized onto the pressure roller 20 through the fixing film 13, and thereby the fixing nip portion (nip portion) N having a predetermined width is formed by the surface of the pressure roller 20 and the surface of the fixing film 13 (see FIG. 2). In other words, the pressure roller 20 forms the fixing nip portion N with the heater 11 through the fixing film 13. That is, the nip portion forming unit comes into contact with the inner face of the belt 13, and forms the nip portion which sandwiches and conveys the recording material together with the pressure roller 20. Incidentally, the heater 11, the heat insulation holder 12 and the metal stay 14 are components which are longer than the belt 13, in the generatrix direction of the belt 13.

### (2-4) Heating and Fixing Operation

The rotation of an output axis of a drive motor (not-shown) which is rotationally driven according to a command to print is transmitted to a drive gear (not-shown) provided in an end in the longitudinal direction of the cored metal 21 of the pressure roller 20, through a predetermined speed reduction mechanism (not-shown). Thereby, the pressure roller 20 rotates to an arrow direction at a predetermined peripheral velocity (process speed). The rotation of the pressure roller 20 is transmitted to the surface of the fixing film 13 by a frictional force which works between the surface of the pressure roller 20 and the surface of the fixing film 13, through the fixing nip portion N. Thereby, the fixing film 13 follows the rotation of the pressure roller 20 while the inner face of the fixing film 13 comes into contact with the surface of the protection layer 11c of the heater 11, and rotates in the arrow direction.

A lubricant like a heat resistant grease such as a fluorine-based grease and a silicone-based grease intervenes between the inner face of the fixing film 13 and the surface of the protection layer 11c of the heater 11. Thereby, a frictional resistance between the inner face of the fixing film 13 and the surface of the protection layer 11c of the heater 11 is reduced to become low, and a smooth rotation of the fixing film 13 is secured.

In addition, an energization control circuit (not-shown) of an energization control unit energizes the current-energized resistance layer 11b of the heater 11 according to the command to print. Thereby, the current-energized resistance layer 11b rapidly raises its temperature, and the heater 11 heats the fixing film 13. The temperature of the heater 11 is detected by a temperature detecting element 17 (see FIG. 2) such as a thermistor provided on the rear surface of the substrate 11a in an opposite side to the fixing nip portion N. The energization control circuit captures a signal output from the temperature detecting element 17, determines a duty ratio, a frequency and the like of a voltage to be applied to the current-energized resistance layer 11b based on the signal, and keeps the temperature of the fixing nip portion N to a predetermined set temperature for fixing (target temperature).

In a state in which the drive motor is rotationally driven and the current-energized resistance layer 11b of the heater 11 is energized, and the temperature of the fixing nip portion N is kept at the predetermined set temperature for fixing, the recording material P having an unfixed toner image t carried thereon is introduced into the fixing nip portion N so that the surface having the toner image carried thereon faces upward. The recording material P is sandwiched by the surface of the fixing film 13 and the surface of the pressure roller 20 in the fixing nip portion N, and is conveyed therethrough. In the conveyance process, the toner image t on the recording material is heated by the heater 11 through the fixing film 13 and is melted. At the same time, the toner image t receives a nip pressure of the fixing nip portion N, and is heated and fixed onto the recording material. The recording material P on which the toner image t has been heated and fixed is separated from the surface of the fixing film 13, and is discharged from the fixing nip portion N.

### (2-5) Shift Regulation Portions 12a and 12b of Heat Insulation Holder 12

As is illustrated in FIG. 3A, a shift regulation portion (regulation portion) 12a having a regulation face 12a1 for regulating a shift (movement) of the fixing film 13 to the longitudinal direction is provided in one end in the longitudinal direction of the heat insulation holder 12. The shift regulation portion 12a is arranged so that the regulation face 12a1 opposes the end face in the one end in the longitudinal direction of the fixing film 13, at a predetermined gap ga. In addition, as is illustrated in FIG. 3B, the shift regulation portion 12a is provided on the ends in the upper-stream side of the recording material conveyance direction and the down-stream side of the recording material conveyance direction, in the transverse direction of the heat insulation holder 12. In addition, FIG. 3C illustrates a perspective view of the heat insulation holder 12 with which the shift regulation portion 12a has been integrally molded.

A shift regulation portion (regulation portion) 12b having a regulation face 12b1 for regulating the shift (movement) of the fixing film 13 to the longitudinal direction is provided in the other end in the longitudinal direction of the heat insulation holder 12. The shift regulation portion 12b is arranged so that the regulation face 12b1 opposes the end face in the other end in the longitudinal direction of the fixing film 13, at a predetermined gap gb. In addition, as is illustrated in FIG. 3B, the shift regulation portion 12b is provided on the ends in the upper-stream side of the recording material conveyance direction and the down-stream side of the recording material conveyance direction, in the transverse direction of the heat insulation holder 12.

Both of the above described two shift regulation portions 12a and 12b are molded integrally with the heat insulation holder 12 according to a molding method such as an injection molding method, and have such a shape as to be symmetrical with respect to the center c in the longitudinal direction of the fixing apparatus 3. Thus, one of the regulation portions each is provided at a position which opposes one end face of the belt and at a position which opposes the other end face thereof, and the two regulation portions are both molded integrally with a component having a longer length than that of the belt.

The metal stay 14 is a member having a longer length than that of the fixing film 13. Both ends in the longitudinal direction of the metal stay 14 are extended to the outside of the shift regulation portions 12a and 12b, and receive a pressurization force of the pressure spring 19, in spring receiving portions 14a and 14b provided on the ends in the outer side than the shift regulation portions 12a and 12b.

A positional relationship between the shift regulation portions 12a and 12b, and the end face in the longitudinal direction of the fixing film 13 (hereinafter referred to as end face of fixing film 13) will be described below with reference to FIG. 3B. As is illustrated in FIG. 3B, the outline of the end face of the fixing film 13 when the fixing film 13 is not rotated is approximately equal to the trajectory of the fixing film 13 (see FIG. 2) when the fixing film 13 is rotated.

When the recording material p is sandwiched by the fixing nip portion N and is conveyed therethrough, or follows the pressure roller 20 and is rotated, the fixing film 13 occasionally receives such a shift force as to move the fixing film 13 to one end side or the other end side in the longitudinal direction of the fixing film 13. In order to regulate the movement of the fixing film 13 by the shift regulation portions 12a and 12b, the shift regulation portions 12a and 12b need to project to the outer side than the trajectory of the fixing film 13, in a diameter direction of the fixing film 13. This is necessary in order that when the fixing film 13 has moved to the one end side or the other end side in the longitudinal direction thereof, the shift regulation portion regulates the movement of the fixing film 13 by bringing the end face of the fixing film 13 into contact with the regulation faces 12a1 and 12b1.

On the other hand, when the shift regulation portion is structured so that the whole region of the end face of the fixing film 13 can come into contact with the regulation faces 12a1 and 12b1 for the end of the fixing film, the fixing film 13 cannot be inserted into the heat insulation holder 12 which supports the heater 11 and the metal stay 14, when the fixing assembly 10 is assembled.

Then, the heat insulation holder 12 needs to have such a dimension as to be insertable into the fixing film 13. For this reason, the fixing film 13 is structured so that a part of the trajectory of the end face of the fixing film 13 comes into contact with the shift regulation portions 12a and 12b in a state in which the fixing film 13 rotates.

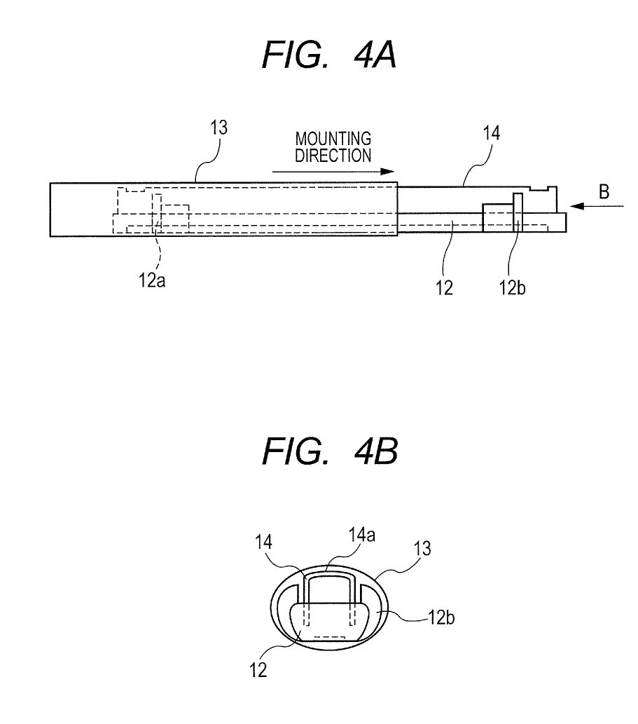

A method for mounting the fixing film 13 on the heat insulation holder 12 which supports the heater 11 and the metal stay 14 will be described below with reference to FIGS. 4A and 4B. FIG. 4A is a front view illustrating a state in which the fixing film 13 is mounted on the heat insulation holder 12 that supports the heater 11 and the metal stay 14. FIG. 4B is a side view illustrating the heat insulation holder 12 which supports the heater 11 and the metal stay 14, and the fixing film 13, in FIG. 4A, when viewed from the direction of the arrow B.

As is clear from FIG. 4B, the fixing film 13 is in a state in which the fixing film 13 does not come into contact with the pressure roller 20, when the fixing assembly 10 is assembled. Because of this, the fixing film 13 can be deflected to an ellipse shape more largely than a shape when the fixing film 13 comes into contact with the pressure roller 20, as illustrated in FIGS. 3A to 3C. The fixing film 13 can be mounted on the heat insulation holder 12 which supports the heater 11 and the metal stay 14, in a state in which the end face of the fixing film 13 has been largely deflected to the ellipse shape.

In other words, the end face of the fixing film 13 is largely deflected to the ellipse shape, and thereby the interference can be avoided which occurs between the end face of the fixing film 13, and the shift regulation portions 12a and 12b of the heat insulation holder 12 and a ceiling portion 14a of the metal stay 14. In other words, if the shift regulation portions 12a and 12b have fitted in the inner side than the outline of the fixing film when the fixing film 13 is deflected to the ellipse shape, the fixing film 13 can be inserted into the heat insulation holder 12 which supports the heater 11 and the metal stay 14. Thereby, the fixing assembly 10 can be simply assembled.

When the above description is considered, the shift regulation portions 12a and 12b need to project to the outer side in a diameter direction of the fixing film 13 than the trajectory of the end face of the fixing film 13 in a state in which the fixing film 13 is pressurized by the pressure roller 20. In addition, the projection amounts of the shift regulation portions 12a and 12b need to be suppressed to such a dimension that the shift regulation portions 12a and 12b do not interfere with the end face of the fixing film 13, when the fixing film 13 is deflected to the ellipse shape and is mounted on the heat insulation holder 12 which supports the heater 11 and the metal stay 14.

In the present embodiment, the regulation faces 12a1 and 12b1 of the shift regulation portions 12a and 12b are set so as to have such a shape as to satisfy the above described two conditions. Specifically, the regulation faces has been set at such a shape as to fit in an inner side than a cross-sectional shape of the fixing film 13 when the fixing film 13 has been deflected to a diameter direction in a state in which the fixing film 13 does not come into contact with the pressure roller 20, and as to project to the outer side than the trajectory of the fixing film 13 during rotation in a state in which the fixing film 13 comes into contact with the pressure roller 20 (in other words, in a state in which the fixing nip portion is formed).

Thus, the regulation portion 12a and the regulation portion 12b have such a size as to be insertable into the inner volume (e.g. cylinder) surrounded by the belt 13. In addition, the regulation portion 12a and the regulation portion 12b have such portions as to project to the outer side in a radial direction of the belt than the outline of the end face of the belt 13 when the apparatus is used, and thereby can regulate the shift movement of the belt 13.

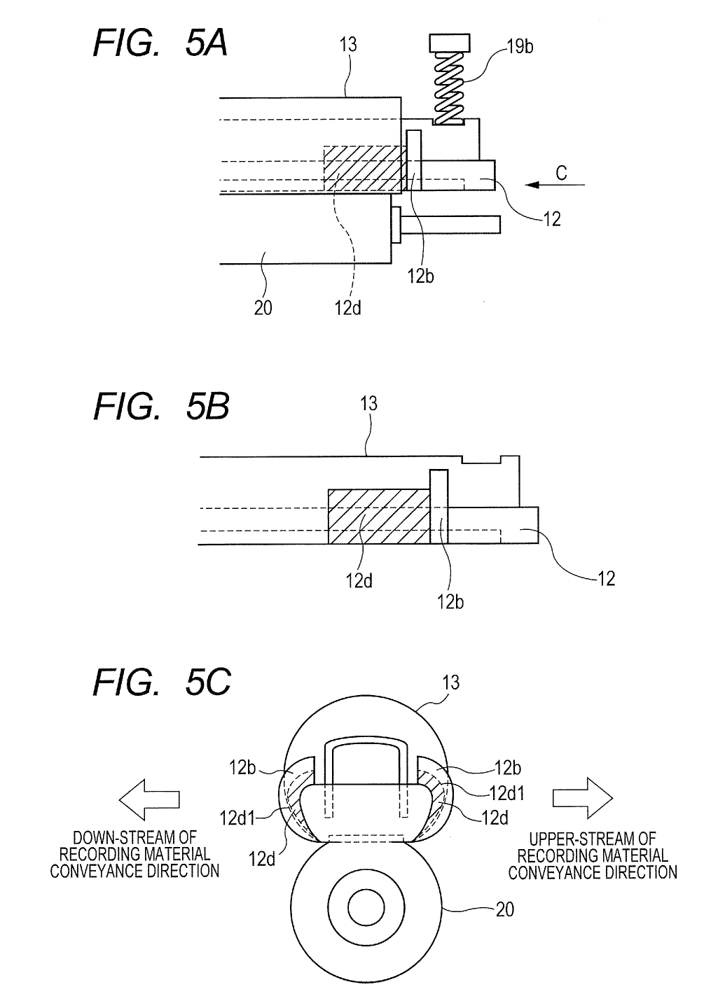

Next, guide portions 12c and 12d provided on a heat insulation holder 12 will be described below with reference to FIGS. 5A to 5C. FIG. 5A is a front view of one side in a longitudinal direction of the fixing film 13 and the pressure roller 20, FIG. 5B is an explanatory drawing of a guide portion 12d provided in one side in a longitudinal direction of the heat insulation holder 12, and FIG. 5C is an enlarged side view of the fixing film 13 and the pressure roller 20 of FIG. 5A when viewed from the direction of the arrow C.

As is illustrated in FIG. 3A, guide portions 12c and 12d for guiding the trajectory of the fixing film 13 during rotation are provided in the inner side of the shift regulation portions 12a and 12b in the longitudinal direction of the heat insulation holder 12. The guide portions 12c and 12d are molded integrally with the heat insulation holder 12, according to a molding method such as an injection molding method. The guide portions 12c and 12d are also arranged so as to be symmetrical to the center c in the longitudinal direction of the fixing apparatus 3.

The guide portion 12c provided in one end in the longitudinal direction of the heat insulation holder 12 out of the guide portions 12c and 12d is provided on the ends in the upper-stream side of the recording material conveyance direction and the down-stream side of the recording material conveyance direction, in the transverse direction of the heat insulation holder 12 (see FIG. 5C). On the other hand, the guide portion 12d provided in the other end in the longitudinal direction of the heat insulation holder 12 is provided on the ends in the upper-stream side of the recording material conveyance direction and the down-stream side of the recording material conveyance direction, in the transverse direction of the heat insulation holder 12 (see FIG. 5C).

The respective outside surfaces in the transverse direction of the heat insulation holder 12 of the guide portions 12c and 12d are formed so as to be arcuate surfaces 12c1 and 12d1 which have approximately the same curvature as the curvature of the fixing film 13 in a state in which the fixing nip portion is formed. The arcuate surfaces 12c1 and 12d1 are structured so as to guide the trajectory of the fixing film 13 during rotation by making the inner face of the fixing film 13 slide on the arcuate surfaces 12c1 and 12d1. Because the fixing apparatus has the guide portions 12c and 12d, the trajectory of the fixing film 13 during rotation is stabilized. Accordingly, even when the fixing film 13 has received a shift force, the trajectory of the fixing film 13 is not disordered, and can keep a state in which the fixing film 13 stably comes into contact with the regulation portions 12a and 12b.

### (3) Examples of Comparative Experiment

Based on the structure of the above described fixing apparatus 3 of the present embodiment, the following comparative experiments were carried out with the use of a fixing apparatus of an embodiment and a fixing apparatus of a comparative example, which would be described below.

### Embodiment 1-1

The fixing apparatus of Embodiment 1-1 has the same structure as that of the fixing apparatus 3 in the present embodiment, except that a heat insulation holder which integrally has only shift regulation portions 12a and 12b in the outside of both ends in the longitudinal direction of the fixing film 13 as is illustrated in FIGS. 3A to 3C was used as the heat insulation holder 12. The material of the heat insulation holder 12 is a liquid crystal polymer, and the shift regulation portions 12a and 12b are also molded of the same material as that of the heat insulation holder 12.

### Embodiment 1-2

The fixing apparatus of Embodiment 1-2 has the same structure as that of the fixing apparatus 3 in the present embodiment, except that a heat insulation holder which has guide portions 12c and 12d for guiding the trajectory of the fixing film 13 during rotation in the inner side of the shift regulation portions 12a and 12b as is illustrated in FIGS. 5A to 5C was used as the heat insulation holder 12. These guide portions 12c and 12d are also molded integrally with the heat insulation holder 12 and the shift regulation portions 12a and 12b. The material of the heat insulation holder 12 is a liquid crystal polymer, similarly to that in Embodiment 1-1.

### Comparative Example

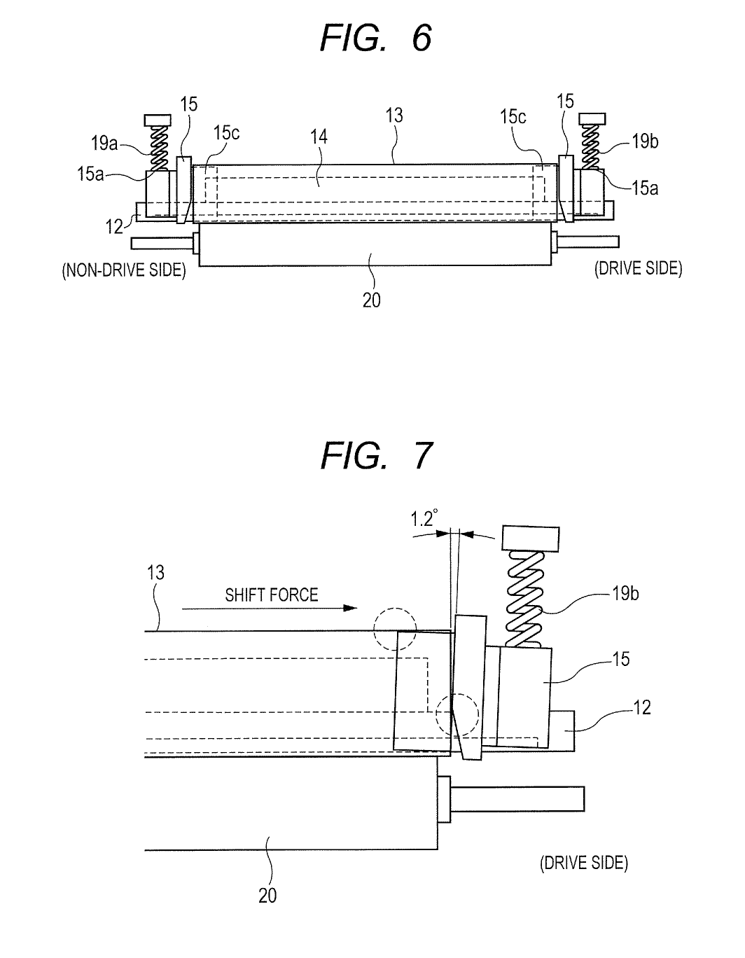

The fixing apparatus of a comparative example has the same structure as that of the fixing apparatus 3 in the present embodiment, except that the fixing apparatus has a shift regulation flange 15 which is provided in both ends in the longitudinal direction of the fixing film 13 separately from the heat insulation holder 12 as is illustrated in FIG. 6. As for the shift regulation flange 15, a fitting portion (not-shown) provided in the shift regulation flange 15 is fitted at least in one end of any of a fixing frame and the heat insulation holder 12 or the metal stay 14. The regulation flange 15 has a guide portion 15c provided therein which guides the trajectory of the fixing film 13 during rotation.

In addition, the fixing apparatus of the comparative example has a spring receiving portion 15a which receives a pressure force from a pressure spring 19, as is illustrated in FIG. 6. The pressure force from the pressure spring 19 is applied to the metal stay 14 through the corresponding regulation flange 15, and thereby the whole metal stay 14 presses the heat insulation holder 12 to the inner face side of the fixing film 13 over the longitudinal direction. The material of the regulation flange 15 is a liquid crystal polymer, similarly to that in Embodiment 1-1 and Embodiment 1-2.

### Comparative Experiment 1

The following experiment was carried out in order to compare effects of fixing apparatuses of Embodiment 1-1, Embodiment 1-2 and the comparative example.

In each of the fixing apparatuses, the pressure force of the pressure spring 19 which is arranged in the both ends in the longitudinal direction of the metal stay 14 is set intentionally so as to become unbalanced. Specifically, the pressure force is set so that an approximately constant shift force is generated in a drive side (drive gear side) of the pressure roller 20 of the fixing film 13. Here, a pressure force of 117.6 N (12 kgf) is applied to a non-drive side (opposite side to drive gear) of the pressure roller 20, and a pressure force of 78.4 N (8 kgf) is applied to the drive side of the pressure roller 20. The pressure force of the pressure spring 19 was set in this way, and thereby was adjusted so as to generate a shift force of approximately 6.37 N (650 gf) in the drive side direction of the pressure roller 20 of the fixing film 13 when the fixing apparatus was operated.

In addition, in the fixing apparatus of the comparative example, the regulation flange 15 is set in a state in which the regulation flange 15 tilts to the outside in the longitudinal direction by 1.2 degrees, as is illustrated in FIG. 7. This is a tilt that is generated by the pressure force which the regulation flange 15 receives from the pressure spring 19, and is a tilt that can be generated when a clearance and the like are considered at the maximum, which occur within a production range because there is a component tolerance in a fitting portion of the heat insulation holder 12 and the metal stay 14. The fixing apparatus is set so that the regulation flange 15 and the fixing film 13 are locally brought into contact with each other in circular portions surrounded by dot lines in the figure, and so that stresses are applied to the fixing film 13.

On the other hand, in the fixing apparatuses of Embodiment 1-1 and Embodiment 1-2, the shift regulation portions 12a and 12b are molded integrally with the heat insulation holder 12, and accordingly a tilt as in the regulation flange 15 of the fixing apparatus of the comparative example does not occur.

In this state, a sheet-feeding durability test was carried out, and the presence or absence of a damage and a wear of the end face of the fixing film 13 was confirmed. Plain paper having a basis weight of 75 g/m² was used as the paper for the sheet-feeding durability test. The result is shown in Table 1. Table 1 shows a result obtained by having observed a state of the fixing film 13 for every fixed number of sheets. When the damage and the wear were not observed on the end face of the fixing film 13 and its periphery, after 50,000 sheets, 100,000 sheets, 150,000 sheets, 200,000 sheets and 250,000 sheets of paper were fed, the result was evaluated to be good. In addition, when the damage and the wear were clearly confirmed, and paper could not be fed any more, the result was evaluated to be poor. When a slight wear is observed but sheet-feeding can be continued, the result is represented so as to be fair.

### Comparative Experiment 2

In addition, as for Comparative Experiment 2, in each of the fixing apparatuses, the pressure force of the pressure spring 19 was adjusted so as to generate a shift force of approximately 6.37 N (650 gf) in a drive side direction of the pressure roller 20 of the fixing film 13, by a similar setting to the above described setting.

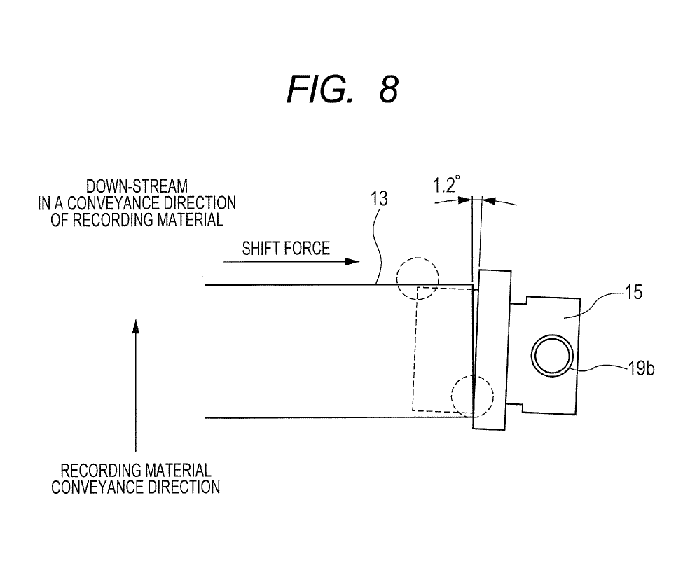

In addition, in the fixing apparatus of the comparative example, the regulation flange 15 is set in a state in which the regulation flange 15 tilts to the down-stream side in the sheet-feeding direction by 1.2 degrees, as is illustrated in FIG. 8. The tilt of the regulation flange 15 can be generated in the following way. Specifically, when the fixing film 13 follows the rotation of the pressure roller 20 and is rotated, such a force as to move the heater 11 and the heat insulation holder 12 to the down-stream side of the recording material conveyance direction acts on the heater 11 and the heat insulation holder 12, due to a frictional force with the inner face of the fixing film 13. The heat insulation holder 12 and the regulation flange 15 are fitted to each other, and accordingly such a force acts also on the regulation flange 15 that the regulation flange 15 also tends to move to the down-stream side of the recording material conveyance direction. However, the regulation flange 15 is fitted in the pressure spring 19 and the fixing frame, and accordingly does not move. Because of this, the spring receiving portion 15a (in position of spring 19b in FIG. 8) functions as a supporting point, and the regulation flange 15 tilts as in FIG. 8.

When there is the clearance due to a component tolerance or the like, it is considered that the regulation flange 15 tilts due to a rotary power toward the above described down-stream side of the recording material conveyance direction. The above described tilt of 1.2 degrees is a tilt which can be generated when the component tolerance, the clearance and the like are considered at the maximum, which occur in production. The fixing apparatus is set so that the regulation flange 15 and the fixing film 13 are locally brought into contact with each other in circular portions surrounded by dot lines in FIG. 8, and so that stresses are applied to the fixing film 13.

On the other hand, in the fixing apparatuses of Embodiment 1-1 and Embodiment 1-2, the shift regulation portions 12a and 12b are molded integrally with the heat insulation holder 12, and accordingly a tilt as in the regulation flange 15 of the fixing apparatus of the comparative example does not occur.

In this state, the sheet-feeding durability test was carried out in a similar way to that in Comparative Experiment 1. The result is shown in Table 2. The state of the fixing film 13 in the durability test is similar to that in the description of the above described Comparative Experiment 1.

TABLE 1
Result of Comparative Experiment 1

| | 50,000 | 100,000 | 150,000 | 200,000 | 250,000 |
|---|---|---|---|---|---|
| | sheets | sheets | sheets | sheets | sheets |
| Embodiment | Good | Good | Good | Good | Fair |
| 1-1 | | | | | |
| Embodiment | Good | Good | Good | Good | Good |
| 1-2 | | | | | |
| Comparative | Good | Poor | — | — | — |
| Example | | | | | |

TABLE 2
Result of Comparative Experiment 2

| | 50,000 | 100,000 | 150,000 | 200,000 | 250,000 |
|---|---|---|---|---|---|
| | sheets | sheets | sheets | sheets | sheets |
| Embodiment | Good | Good | Good | Good | Fair |
| 1-1 | | | | | |
| Embodiment | Good | Good | Good | Good | Good |
| 1-2 | | | | | |
| Comparative | Good | Fair | Poor | | |
| Example | | | | | |

As is clear from the above described results of Tables 1 and 2, in the fixing apparatus of the comparative example, the damage of the end of the fixing film 13 and the wear of the inner face of the fixing film 13 occur as a result of sheet-feeding of the order of 100,000 to 150,000 sheets. In contrast to this, in the fixing apparatuses of Embodiment 1-1 and Embodiment 1-2, the wear and the damage of the fixing film 13 have not occurred even when 250,000 sheets have been fed, from which it can be understood that an adequate state has been kept. This is because in the fixing apparatus of the comparative example, a large stress continues to be applied onto the sliding portion of the fixing film 13 and the regulation flange 15, as is illustrated in the circular portions surrounded by the dot lines in FIGS. 7 and 8.

On the other hand, when the shift regulation portions 12a and 12b are molded integrally with the heat insulation holder 12 as in the fixing apparatus of the present embodiment, a tilt as in the regulation flange 15 does not occur in the shift regulation portions 12a and 12b. Because of this, the stress which the fixing film 13 receives is reduced, and the damage which the fixing film 13 receives through the durability test can be reduced.

As described above, the fixing apparatus 3 of the present embodiment can regulate the movement of the fixing film 13 to the longitudinal direction by the shift regulation portions 12a and 12b which are provided on the heat insulation holder 12 that supports the heater 11. Thereby, the stress can be reduced which causes the damage of the end in the longitudinal direction and wear of the fixing film 13.

### Embodiment 2

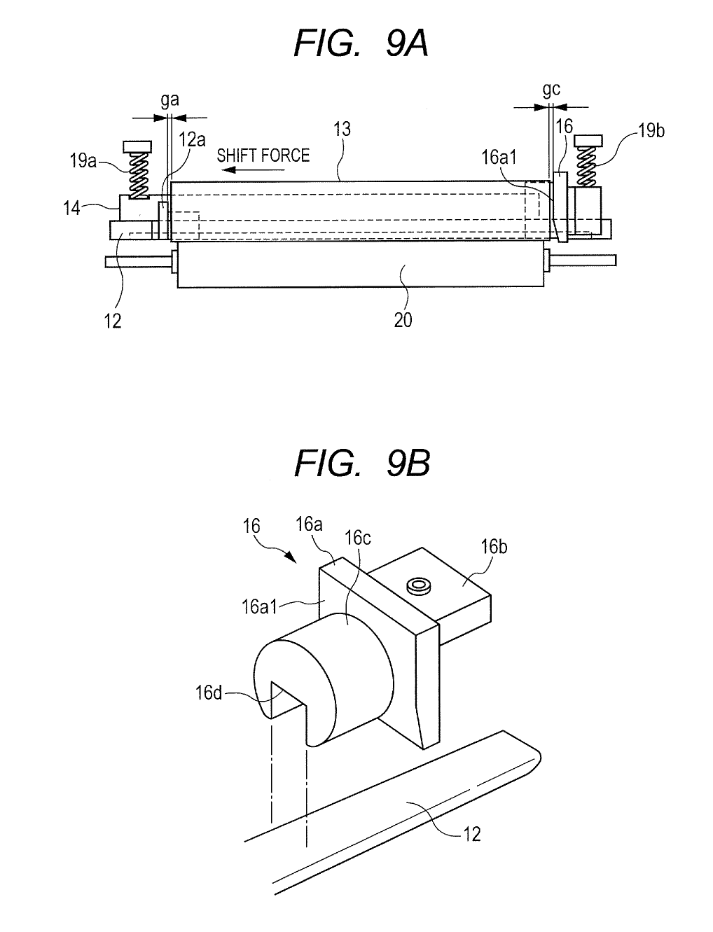

Another embodiment of a fixing apparatus 3 will be described below. FIG. 9A is a front view of the fixing apparatus 3 according to the present embodiment when viewed from the recording material introduction side. FIG. 9B is an explanatory drawing of a shift regulation flange 16 incorporated in the heat insulation holder 12 of the fixing apparatus 3.

The fixing apparatus 3 illustrated in the present embodiment includes a shift regulation portion which has been molded integrally with the heat insulation holder 12, in any one end out of one end and the other end in the longitudinal direction of the heat insulation holder 12. Specifically, any one shift regulation portion out of the shift regulation portions in the one end and in the other end in the longitudinal direction of the heat insulation holder 12 is molded integrally with the heat insulation holder 12, and the other shift regulation portion is molded separately from the heat insulation holder 12. Thus, in the apparatus in the present embodiment, one of the regulation portions each is provided at a position which opposes one end face of the belt and at a position which opposes the other end face thereof, and only one regulation portion is molded integrally with a component having a longer length than that of the belt. In addition, the regulation portion 16 which opposes the other end face of the belt has such a size as to not be insertable into the cylinder of the belt.

The fixing apparatus 3 of the present embodiment is structured so as to have the shift regulation flange 16 as a shift regulation portion which has been molded separately from the heat insulation holder 12, on the other end of the heat insulation holder 12 in the opposite side to the shift regulation portion 12a which has been molded integrally with the heat insulation holder 12, as illustrated in FIGS. 9A and 9B.

The shift regulation flange 16 has the same structure as that of the regulation flange 15 which has been described in Embodiment 1, and has a substrate 16a which opposes the end face in the other end in the longitudinal direction of the fixing film 13. In the substrate 16a, the face in the fixing film 13 side is formed to be a regulation face 16a1 which regulates a shift (movement) of the fixing film 13 to the longitudinal direction. On the regulation face 16a1 in the end of the fixing film, a guide portion 16c for guiding the trajectory of the fixing film 13 during rotation is formed so as to project toward the fixing film 13. Furthermore, the spring receiving portion 16b for the pressure spring 19 is formed in the opposite side to the guide portion 16c of the substrate 16a.

As for the shift regulation flange 16, the spring receiving portion 16b is supported by the fixing frame, and simultaneously a groove portion 16d provided in the bottom part of the substrate 16a and the guide portion 16c is fitted in the other end in the longitudinal direction of the heat insulation holder 12. Thus, the shift regulation flange 16 is structured so as to be incorporated in the heat insulation holder 12.

In the fixing apparatus 3 of Embodiment 1, the shift regulation portions 12a and 12b are molded integrally with the heat insulation holder 12 on both ends in the longitudinal direction of the heat insulation holder 12. Because of this, in an assembly operation of the fixing assembly 10, when the fixing film 13 is mounted on the heat insulation holder 12 which supports the heater 11 and the metal stay 14, it has been necessary to insert the heat insulation holder while deflecting the end face of the fixing film to the ellipse shape so that the fixing film 13 is not brought into contact with the shift regulation portion (FIGS. 4A and 4B).

In the fixing apparatus 3 of the present embodiment, when the fixing assembly 10 is assembled, firstly, the fixing film 13 is mounted from the end side of the heat insulation holder 12 that supports the heater 11 and the metal stay 14, in which the shift regulation flange 16 is to be incorporated. The shift regulation flange 16 may be incorporated in the heat insulation holder 12 after the fixing film 13 has been mounted. In the shift regulation flange 16 which has been incorporated in the heat insulation holder 12, the regulation face 16a1 opposes the end face of the other end in the longitudinal direction of the fixing film 13 at a predetermined gap gc (see FIG. 9A).

The fixing apparatus 3 of the present embodiment does not need to deflect the end face of the fixing film to the ellipse shape when the fixing assembly is assembled, as in the fixing apparatus 3 of Embodiment 1, and accordingly can enhance assembly properties of the fixing assembly 10. In addition, the regulation portion 16 is a different component from the heat insulation holder, and accordingly the flexibility of the size and the shape of the shift regulation portion 12a of the heat insulation holder 12 is enhanced.

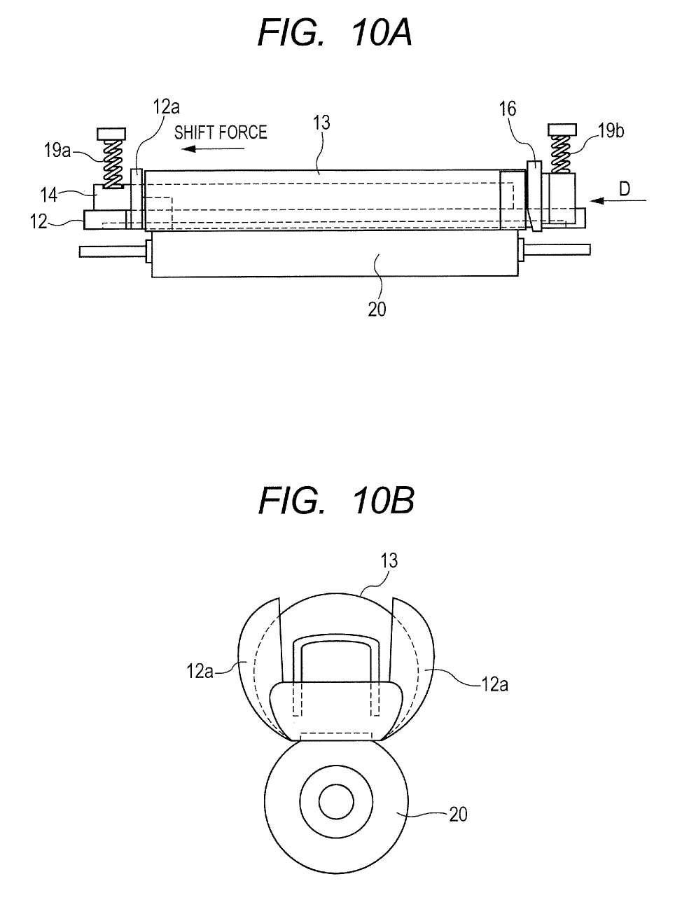

The reason why the flexibility of the size and the shape of the shift regulation portion 12a of the heat insulation holder 12 can be enhanced will be described below. FIGS. 10A and 10B illustrate one example of the shift regulation portion 12a of the heat insulation holder 12. FIG. 10A is a front view of the fixing apparatus 3 according to the present embodiment when viewed from the recording material introduction side, and is a view illustrating one example of the size of the shift regulation portion 12a of the heat insulation holder 12. FIG. 10B is an enlarged side view of the fixing apparatus of FIG. 10A when viewed from the direction of the arrow D, and is a view illustrating one example of a shape of the shift regulation portion 12a of the heat insulation holder 12.

For instance, the size of the shift regulation portion 12a of the heat insulation holder 12 can be expanded to the peripheral direction of the fixing film 13 than that of the shift regulation portion 12a in Embodiment 1 illustrated in FIG. 3A (see FIGS. 10A and 10B). The shift regulation portion 12a illustrated in FIG. 10B has such a size as to not be insertable into the cylinder of the belt 13.

When the size and the shape of the regulation face 12a1 of the shift regulation portion 12a are expanded in this way, even if the shift force of the fixing film 13 to the shift regulation portion has increased, for instance, a pressure given to the unit area of the end face of the fixing film 13 can be dispersed. Because of this, a local force tends to be easily reduced which causes a damage in the end in the longitudinal direction of the fixing film 13. Specifically, the stress can be reduced which causes the damage of the end in the longitudinal direction and wear of the fixing film 13.

On the other hand, when the shift force of the fixing film 13 acts on a direction of the shift regulation flange 16 provided on the heat insulation holder 12, the regulation flange 16 may result in easily giving a damage to the end face of the fixing film 13 due to the clearance and the tilt of the regulation flange 16, as in the above described fixing apparatus of the comparative example. Accordingly, in the fixing apparatus 3 of the present embodiment, it is desirable to control the shift force of the fixing film 13 so as to act on a direction of the shift regulation portion 12a provided on the heat insulation holder 12.

Various methods are considered as methods for controlling the direction of the shift of the fixing film 13, but one example includes the following structure.

One is a method, for instance, of setting a pressure force of the pressure spring 19a and a pressure force of the pressure spring 19b so as to be unbalanced. Thereby, the shift force of the fixing film 13 can be controlled so as to act on one direction in the longitudinal direction of the fixing film 13, in other words, only on the direction of the shift regulation portion 12a provided on the heat insulation holder 12. In this method, the pressure force is set so as to be unbalanced, and thereby, on the contrary, the shift force results in increasing. Accordingly, the pressure force needs to be controlled in such a range as not to exert a damage on the end in the longitudinal direction of the fixing film 13.

In addition, as another example, there is a method of forming spiral unevenness as in illustrated in FIG. 11 on the inner face of the used fixing film 13. Thereby, the fixing apparatus can control the direction of the shift of the fixing film 13. Such a spiral unevenness can be easily obtained by being formed when the fixing film 13 is produced.

When a growth of a work (object to be worked) is promoted to a longitudinal direction while the work is rotated during the production of the film, for instance, the spiral unevenness can be given to the fixing film 13 by the adjustment of a rotation speed and a feed per revolution in the longitudinal direction, and the like. Alternatively, the spiral unevenness may be given to the fixing film 13 by post processing or the like. This method causes heat resistance on a contact face with the heater 11 as a space between the salients of the unevenness increases which is formed on the inner face of the fixing film 13. Accordingly, the unevenness needs to be suppressed to such an extent as not to impair a thermal conduction performance. As another application example of this method, there is a method of giving an oblique uneven line onto a sliding face of the heater 11, on which the inner face of the fixing film 13 slides. A similar effect can be expected also by the method.

As further another example for controlling the direction of the shift of the fixing film 13, there is a method of making the whole fixing assembly 10 cross an axial direction of the pressure roller 20. Furthermore, there is also a method of forming the end face in the longitudinal direction of the fixing film 13 or the pressure roller 20, into a tapered shape, and thereby providing a difference between left and right peripheral lengths of the fixing film 13 or the pressure roller 20. Furthermore, there is also a method of providing a projecting portion or the like, which comes into contact with the inner face of the fixing film 13, in a part of the heat insulation holder 12, and generating a shift force toward one direction of the longitudinal direction of the fixing film 13.

Here, the method for controlling the direction of the shift of the fixing film 13 is not limited to the above described methods, and any method and structure may be adopted as long as the direction of the shift of the fixing film 13 can be controlled by balance with or adjustment by other members of the fixing apparatus.

### Embodiment 3

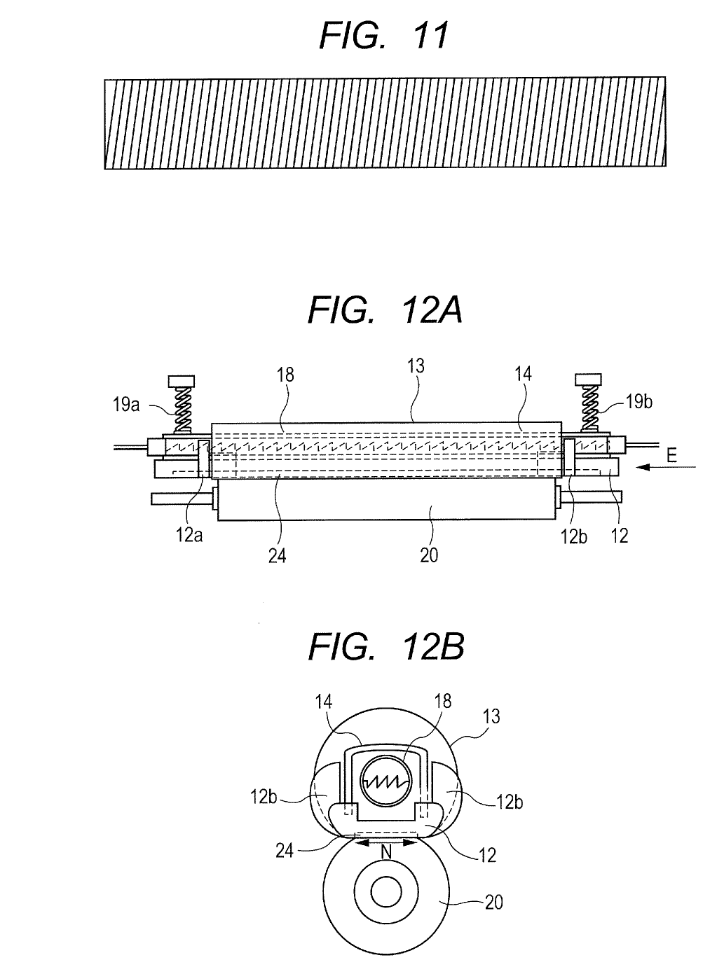

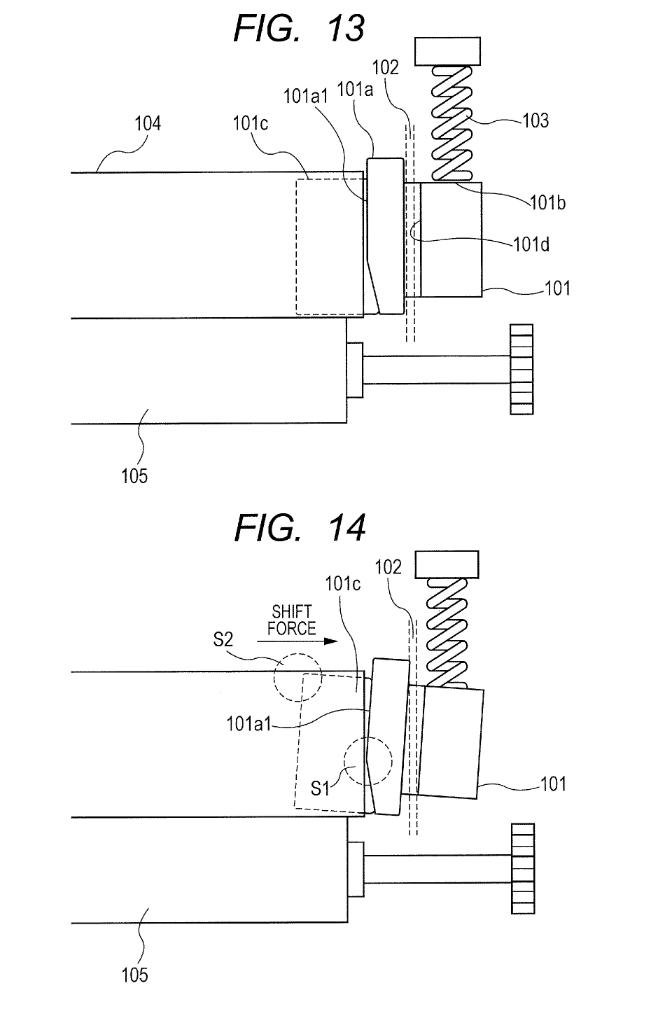

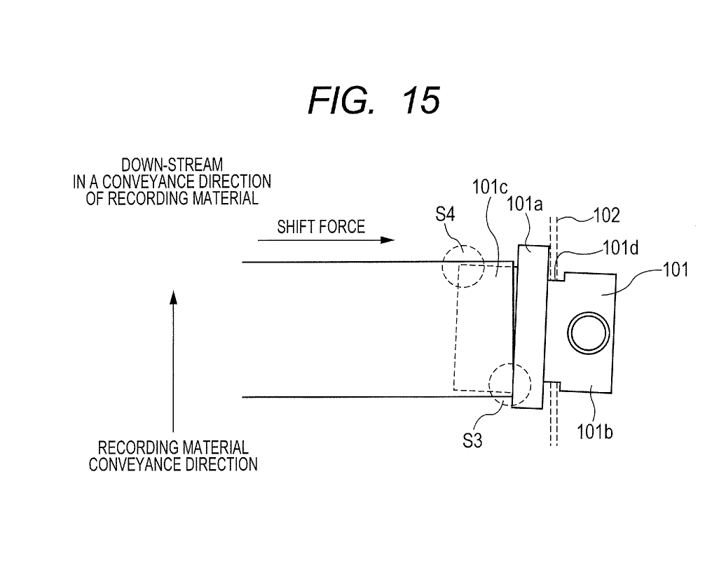

Another example of the fixing apparatus 3 will be described below. FIG. 12A is a front view of the fixing apparatus 3 according to the present embodiment when viewed from the recording material introduction side, and FIG. 12B is an enlarged side view of the fixing apparatus 3 of FIG. 12A when viewed from the direction of the arrow E.

In the fixing apparatus 3 illustrated in the present embodiment, a halogen heater 18 is used as a heating element, and the halogen heater 18 is arranged between a heat insulation holder 12 and a metal stay 14. The halogen heater 18 is supported by the heat insulation holder 12 or the metal stay 14 through a bracket (not-shown), in both ends in the longitudinal direction. In addition, a pressure plate 24 of a pressure member is supported by the heat insulation holder 12 so as to oppose the pressure roller 20 through the fixing film 13.

Both ends in the longitudinal direction of the metal stay 14 which is supported by the heat insulation holder 12 are pressurized toward the heat insulation holder 12 by pressure springs 19a and 19b, and thereby the pressure plate 24 is pressurized to the pressure roller 20 through the fixing film 13. An elastic layer 22 in the pressure roller 20 is elastically deformed in a region in which the pressure plate 24 is pressurized to the pressure roller through the fixing film 13, and thereby a fixing nip portion (nip portion) N having a predetermined width is formed by the surface of the pressure roller 20 and the surface of the fixing film 13. Specifically, the pressure roller 20 forms the fixing nip portion N with the pressure plate 24, through the fixing film 13.

In the fixing apparatus 3 of the present embodiment, it is desirable that the pressure plate 24 is a plate-shaped substrate with high thermal conductivity so as to efficiently transmit heat from the halogen heater 18 to the fixing film 13. A material of the pressure plate 17 may be a metal plate obtained by molding a metal material such as SUS, nickel, copper and aluminum solely or as an alloy thereof, a glass plate, or a heat resistant resin such as polyimide, other than a ceramic substrate of alumina, aluminum nitride or the like. In addition, in order to adequately keep sliding properties with the inner face of the fixing film 13, the pressure plate may have a sliding layer of polyimide, a fluorine resin, diamond-like carbon (DLC) or the like formed on the surface in the fixing film 13 side.

Furthermore, the pressure plate 24 has optimally a thickness of approximately 0.3 mm to 2.0 mm, in order to have a sufficient strength and also suppress heat capacity. In the present embodiment, the heat insulation holder 12 corresponds to a component which has a longer length than that of a belt 13.

Other members have similar functions to those of the fixing apparatuses in Embodiment 1 and Embodiment 2. In the fixing apparatus 3 of the present embodiment, the metal stay 14 may have a structure in which a part of the metal stay 14 is cut away so that a radiant heat is transmitted directly onto the inner face of the fixing film, in order that the radiant heat from the halogen heater 18 is more efficiently transmitted to the fixing film 13. Similarly, when the part of the heat insulation holder 12 is cut away so that the radiant heat from the halogen heater 18 is transmitted directly onto the pressure plate 24, the fixing film 13 can be more effectively heated.

Also in the fixing apparatus 3 of the present embodiment, shift regulation portions 12a and 12b for regulating the shift of the fixing film 13 are provided on both ends of the heat insulation holder 12 in the longitudinal direction. These shift regulation portions 12a and 12b are molded integrally with the heat insulation holder 12. Because the shift regulation portions 12a and 12b are molded integrally with the heat insulation holder 12, an action effect similar to that of the fixing apparatus 3 in Embodiment 1 can be obtained.

Also in the fixing apparatus 3 of the present embodiment, only one regulation portion may be molded integrally with the heat insulation holder 12, in a similar way to that of the fixing apparatus 3 in Embodiment 2. Thereby, an action effect similar to that of the fixing apparatus 3 in Embodiment 2 can be obtained.

### Other Embodiment

The above described image heating apparatus is not limited to uses as an apparatus which heats and fixes an unfixed toner image onto a recording material. The image heating apparatus can be also used, for instance, as an apparatus which temporarily fixes the unfixed toner image onto the recording material, or an apparatus which heats a toner image that has been already heated and fixed onto the recording material to impart glossiness to the surface of the toner image.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2012-089998, filed Apr. 11, 2012, which is hereby incorporated by reference herein in its entirety.

What is claimed is:

1. An image heating apparatus for heating an image formed on a recording material, comprising:
an endless belt;
a roller which contacts an outer face of the belt;
a nip portion forming unit which contacts an inner face of the belt, and forms a nip portion with the roller, for nipping and conveying a recording material, the nip portion forming unit including a component which is longer than the belt in a generatrix direction of the belt; and
a regulation portion provided to oppose an end face of the belt, for regulating a shift movement of the belt to the generatrix direction of the belt,
wherein the regulation portion is integrally-molded with the component.

2. An image heating apparatus according to claim 1, further comprising another regulation portion provided to oppose another end face of the belt, and the regulation portion and the another regulation portion are both integrally molded with the component.

3. An image heating apparatus according to claim 1, further comprising another regulation portion provided to oppose another end face of the belt, and the another regulation portion is not integrally molded with the component.

4. An image heating apparatus according to claim 1,
wherein the regulation portion has a size in which the regulation portion is insertable into a cylinder of the belt, and
wherein the regulation portion includes a portion that projects from an outline of the end face of the belt in a radial direction of the belt to regulate a shift of the belt when the apparatus is used.

5. An image heating apparatus according to claim 3,
wherein the regulation portion opposing the end face of the belt has a size in which the regulation portion is not insertable into a cylinder of the belt.

6. An image heating apparatus according to claim 3,
wherein the another regulation portion which opposes the another end face of the belt has a size in which the another regulation portion is not insertable into a cylinder of the belt.

7. An image heating apparatus according to claim 1,
wherein the belt is configured to shift only toward the regulation portion.

8. An image heating apparatus according to claim 1, further comprising a spring which applies pressure for forming the nip portion,
wherein the nip portion forming unit has a support member for reinforcing the component, and
the spring contacts the support member and directly applies the pressure to the support member.

9. An image heating apparatus according to claim 1,
wherein the component has a guide groove for mounting a frame of the apparatus.

10. An image heating apparatus according to claim 1, further comprising a heater for heating the belt.

11. An image heating apparatus according to claim 10,
wherein the heater is a part of the nip portion forming unit, and the heater contacts the inner face of the belt.

12. An image heating apparatus according to claim 11,
wherein the component is a holder for holding the heater.
